(19) United States
(12) Patent Application Publication
(10) Pub. No.: US 2005/0138420 A1
(43) Pub. Date: Jun. 23, 2005

(54) Automatic role hierarchy generation and inheritance discovery

(76) Inventors: Govindaraj Sampathkumar, Durham, NC (US); Pratik Gupta, Cary, NC (US); David G. Kuehr-McLaren, Apex, NC (US); Vincent C. Williams, Aliso Viejo, CA (US); Sharon L. Cutcher, Austin, TX (US); Sumit Taank, Austin, TX (US); Brian A. Stube, Cambridge, MA (US); Hari Shankar, Cary, NC (US)

Correspondence Address: COATS & BENNETT, PLLC, P O BOX 5, RALEIGH, NC, 27602, US

(21) Appl. No.: 10/741,904

(22) Filed: Dec. 19, 2003

(51) Int. Cl. H04L 9/00

(52) U.S. Cl. 713/201

(57) ABSTRACT

A role hierarchy is automatically generated by hierarchically ranking roles in a role based control system, each role including a plurality of identities having attributes. Iteratively at each hierarchical level: each non-cohesive role (wherein, in this case, at least one attribute is not possessed by every identity in the role) is replaced, at the same hierarchical level, by a cohesive role formed by grouping identities having at least one common attribute. The remaining identities are clustered into children roles based on attributes other than the common attribute, and the children roles are added to the role hierarchy at a hierarchical level below the cohesive role. If no common attribute exists in the non-cohesive role, the role is clustered into two or more new roles based on all the attributes in the role, and the non-cohesive role is replaced with the new roles at the same hierarchical level.

### BACKGROUND OF THE INVENTION

The present invention relates generally to the field of software and in particular to a system and method of automatic role hierarchy generation for role based control systems.

Role based control systems comprise an emerging and promising class of control systems that simplify and streamline the control task by elevating system control rules and decisions from the individual user or process level to a group level. In particular, the grouping of identities in a role based control system reflects the roles the corresponding individuals have as part of an organization that owns, controls, and/or manages the system.

The most common application for role based control systems is Role Based Access Control (RBAC). With respect to RBAC, access is defined as the ability to utilize a system, typically an Information Technology (IT) resource, such as a computer system. Examples of ways one may utilize a computer include executing programs; using communications resources; viewing, adding, changing, or deleting data; and the like. Access control is defined as the means by which the ability to utilize the system is explicitly enabled or restricted in some way. Access control typically comprises both physical and system-based controls. Computer-based access controls can prescribe not only which individuals or processes may have access to a specific system resource, but also the type of access that is permitted. These controls may be implemented in the computer system or in external devices.

With RBAC, access decisions are based on the roles that individual users have as part of an organization. Users take on assigned roles (such as engineer, manager, and human resources (HR) personnel). Access rights are grouped by role name, and the use of resources is restricted to individuals authorized to assume the associated role. For example, an HR employee may require full access to personnel records from which engineers should be restricted to preserve privacy, and engineers may require full access to technical design or product data from which HR employees should be restricted to preserve secrecy, while engineering managers require limited access to both types of data. Rather than set up (and maintain) each individual employee's access controls to the personnel and technical data, under RBAC, three roles may be defined: HR, engineer, and manager. All individuals in the organization who perform the associated role are grouped together, and access controls are assigned and maintained on a per-group basis.

The use of roles to control access can be an effective means for developing and enforcing enterprise-specific security policies, and for streamlining the security management process. User membership into roles can be revoked easily and new memberships established as job assignments dictate. New roles and their concomitant access privileges can be established when new operations are instituted, and old roles can be deleted as organizational functions change and evolve. This simplifies the administration and management of privileges; roles can be updated without updating the privileges for every user on an individual basis.

The current process of defining roles, often referred to as role engineering, is based on an analysis of how an organization operates, and attempts to map that organizational structure to the organization's IT infrastructure. This “top-down” process requires a substantial amount of time and resources, both for the analysis and implementation. The prospect of this daunting task is itself a significant disincentive for organizations using traditional access control methods to adopt RBAC.

Co-pending application Ser. No. ______ discloses an automated “bottom-up” role discovery process that exhibits numerous advantages over the traditional top-down role engineering methods. In this process, existing roles in the organization are discovered by an analysis of the organization's IT infrastructure. In particular, access roles are discovered by an analysis of the existing IT system security structure. For example, user entitlement data—the systems, programs, resources, and data that a user has permission to access or modify—may be extracted for each user. Users with the same or similar entitlements may then be intelligently clustered into groups that reflect their actual, existing roles within the organization. The bottom-up method of role discovery avoids the significant investment in time and effort required to define roles in a top-down process, and also may be more accurate in that it reflects the actual, existing roles of users in the organization, as opposed to an individual's or committee's view of what such roles should look like. Another significant advantage to the bottom-up role discovery process is that it may be automated, taking advantage of powerful data mining tools and methodologies.

However, one problem with automated, bottom-up role discovery is that it generates a large, “flat” plurality of roles, management of which can be unwieldy. The above-referenced copending application describes a multi-pass methodology for aggregating the large plurality of roles into fewer roles; however, they revised roles still tend to be flat, and do not reflect the hierarchical nature of actual roles within most organizations.

### SUMMARY OF THE INVENTION

The present invention relates in one aspect to a method of automatically hierarchically arranging roles in a role based control system, where each role comprises a plurality of identities having attributes, to generate a role hierarchy. According to the method, the following steps are iteratively performed at each level of the hierarchy. Each non-cohesive role (defined in this embodiment as a role wherein at least one attribute is not possessed by every identity in the role) is replaced, at the same hierarchical level, by a cohesive role formed by grouping identities having at least one common attribute. The remaining identities are clustered into child roles based on attributes other than the common attribute, and the child roles are added to the role hierarchy at a hierarchical level below the cohesive role. Regarding the step of replacing each non-cohesive role, if no common attribute exists in the role, the role is clustered into two or more new roles based on all the attributes in the role, and the non-cohesive role is replaced with the new roles at the same hierarchical level.

In another aspect, the present invention relates to a method of automatic role discovery. Identities and associated attributes are extracted from one or more data sources, and the attributes are clustered into roles based on the identities. The roles are then incorporated into a role based control system.

In yet another aspect of the present invention, the roles generated based on identities may be automatically hierarchically arranged to generate a role hierarchy. The method to accomplish this comprises performing the following steps iteratively at each level of the hierarchy. Each non-cohesive role (defined in this embodiment as a role wherein at least one identity does not possess every attribute in the role) is replaced, at the same hierarchical level, by a cohesive role formed by grouping attributes having common identity ownership into said cohesive role. The remaining attributes are clustered into child roles based on identities other than those possessing the common attribute, and the child roles are added to the role hierarchy at a hierarchical level below the cohesive role. Regarding the step of replacing each non-cohesive role, if no identity possesses every attribute in the role, the role is clustered into two or more new roles based on all identities in the non-cohesive role, and the non-cohesive role is replaced with the new roles at the same hierarchical level.

### BRIEF DESCRIPTION OF DRAWINGS

FIG. 1 is a flow diagram of an automatic role hierarchy generating method according to one embodiment of the present invention.

FIG. 2A is a table depicting a representative identity/entitlement matrix.

FIG. 2B is a tree diagram representation of a role hierarchy according to one embodiment of the present invention.

FIG. 3 is a table depicting a representative entitlement/identity matrix.

### DETAILED DESCRIPTION OF THE INVENTION

Role hierarchies, by which one role may implicitly include the characteristics associated with another role, are known in the art. A role hierarchy provides a “gradient” of role characteristics, with many—in many cases, essentially all—individuals participating in the highest-level, most general role, and a variety of more specialized roles beneath this “root” role, each role exhibiting more restrictive characteristics. A member of any role in the hierarchy assumes the characteristics of that role, and additionally of all roles higher up in the hierarchy, from that role up to the root role. As an example, in a RBAC application, all employees of a company may have an email account; this would comprise the access permission of the highest-level, or root, role. Descending from the email root role may be several branches, such as HR, engineering, management, and the like. Each lower-level hierarchical role includes its own access permissions (for example, engineering role having access to technical design and product data). Additionally, each individual in the engineering role would additionally be afforded, or “inherit,” the permissions associated with higher-level roles, such as an email account in this example. Hence, a role hierarchy in an RBAC system establishes a gradient of access permissions, from the most common (typically, the most permissive) at the top, or root (e.g., an email account), to the most specific (typically, the most restrictive) at the lowest levels, or leaves (e.g., access to sensitive financial data, or permission to disable the security systems). Note that the hierarchy may be modeled with the root at the top or the bottom and the leaves in the opposite direction—the inheritance principle is the same either way.

Like the top-down approach to role engineering, role hierarchies are typically constructed manually, often by reference to an organization chart or similar hierarchical breakdown of one or more properties of interest (e.g., access permissions for an RBAC system). This approach suffers many of the pitfalls of traditional flat, top-down role definition. It is a difficult task that requires a significant investment of time and resources. In addition, manual role hierarchy construction is likely to result in a role hierarchy that may not represent the actual gradient of a characteristic (e.g., access) present in the organization.

As discussed above, a common application for role based control systems is Role Based Access Control (RBAC), a security application that restricts and manages users' access to an organization's resources. However, many other role based control systems are possible. While the present invention is described herein as applied to a RBAC system, the invention is not so limited. In general, the role hierarchy generation process of the present invention may be advantageously applied to any role based control system, and the scope of the invention is determined by the claims, and is not limited to the exemplary embodiments and applications described herein.

According to the present invention, a role hierarchy is automatically generated from a flat set of roles that include identities and attributes associated with the identities. The automated role hierarchy generation method of the present invention is particularly suited to forming hierarchical roles from a set of flat roles generated by an automatic, bottom-up role discovery process, although this is not strictly necessary (e.g., the role hierarchy generation method is independent of the source of the flat set of initial roles).

In general, in a flat list of roles, such as may be generated by an automated role discovery process, roles are not related to each other, and also not optimized in terms of memberships or attributes, such as resource entitlements. When policies, such as security policies, are generated based on these role memberships, some members may get access to more resources than those to which they are entitled based on their actual roles within the organization. In other words, the discovered roles are not “tight” from a security point of view, meaning there is less than a complete correspondence between the entitlements held by identities in a role and the corresponding entitlement or access afforded to the role as a whole. These roles should ideally be refined so that they are tight. Further, it may be advantageous to discover the inheritance relation between some roles, for example, learning that an employee in a particular department is a Manager and is also an Engineer. These inheritance relationships are not apparent from a large, flat list of discovered roles.

Roles contain identities, which in turn have attributes. In an RBAC application, an important class of attributes is entitlements. Entitlements, as defined herein, are attributes associated with an identity that define or relate to the user's permissions, authorizations, and levels of access to organization resources. For example, entitlements may include the computer systems to which a user has access (i.e., an account or log-in), the groups to which a user is assigned, file permissions, software or other resource licenses, communications system accesses, and the like.

One metric of discovered roles is a quantity called relevance, which attempts to quantify how well the identity “fits” in the role. For example, if the relevance of an entitlement E1 is quantified as 30%, it means that 30% of the identities in that role possess the entitlement E1. In general, roles such as those automatically generated in a role discovery process may include identities with entitlements that are associated with the role with varying relevance.

If all of the entitlements in a role have 100% relevance, it is defined, in this embodiment, as a cohesive role and need not be further refined. If the role has one or more entitlements that have less than 100% relevance, that role is said to be non-cohesive and is a candidate for further refinement. According to an exemplary embodiment of the present invention, non-cohesive roles are automatically re-clustered and hierarchically arranged to suggest a role inheritance hierarchy of fully cohesive roles.

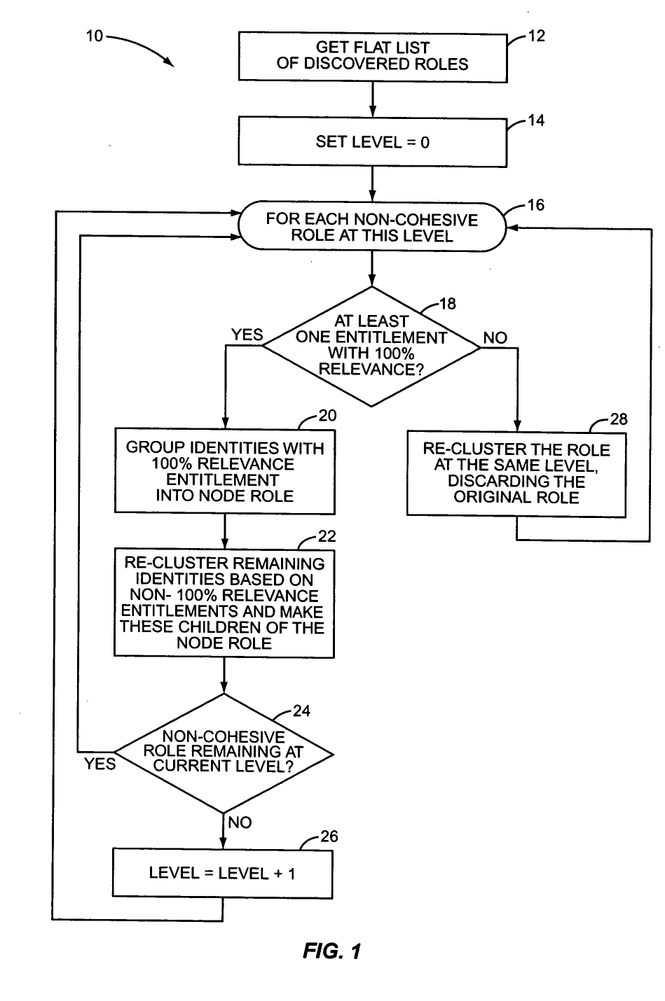

FIG. 1 depicts an algorithm underlying the role hierarchy method of the present invention in flow diagram form, indicated generally by the numeral 10. Initially, a flat list of discovered roles is obtained at step 12. Preferably, the discovered roles are automatically generated based on an intelligent clustering of entitlement data associated with each identity (the identities and entitlement data being obtained, for example, by data mining an organization's computer systems and resources). The flat list of discovered roles will typically be either very large, comprising many small, well-defined roles, or more manageable in size, made up of fewer very large, generalized roles.

The hierarchical level is initialized at step 14. Step 16 begins a loop that executes for every non-cohesive role at the current level. Initially, this will comprise the entire flat list of discovered roles. At step 18, each non-cohesive role is inspected to determine if it includes at least one entitlement with 100% relevance—that is, whether there is at least one entitlement that is common to all identities in the role. If so, a new role is defined at that level comprising the identities having the common entitlements (i.e., the entitlements having 100% relevance in the role) at step 20. This role becomes a node in the hierarchy. At level 0, each such 100% relevance role will be the root node of a separate hierarchy.

The remaining identities are re-clustered into one or more roles based on the non-100% relevance entitlements at step 22. These roles are added to the hierarchy as children nodes to the 100% relevance role created in step 20. The current level is searched for another non-cohesive role at step 24. If found, that non-cohesive role is processed beginning at step 16. If no non-cohesive roles remain at the current level, the level is incremented at step 26, and processing continues for the new level (e.g., the level of the just-created child roles) at step 16.

If, at step 18, no entitlement exists in the non-cohesive role with 100% relevance (i.e., that is common to all identities in the role), then the role is re-clustered at step 28. The re-clustering will destroy the current role, replacing it with two or more roles at the same level that, between them, account for all of the identities contained in the original role. Processing then proceeds from step 16, where each of the newly created non-cohesive roles will be inspected for 100% relevance. The algorithm terminates when only cohesive roles remain at a given level and no children node roles were created (not shown).

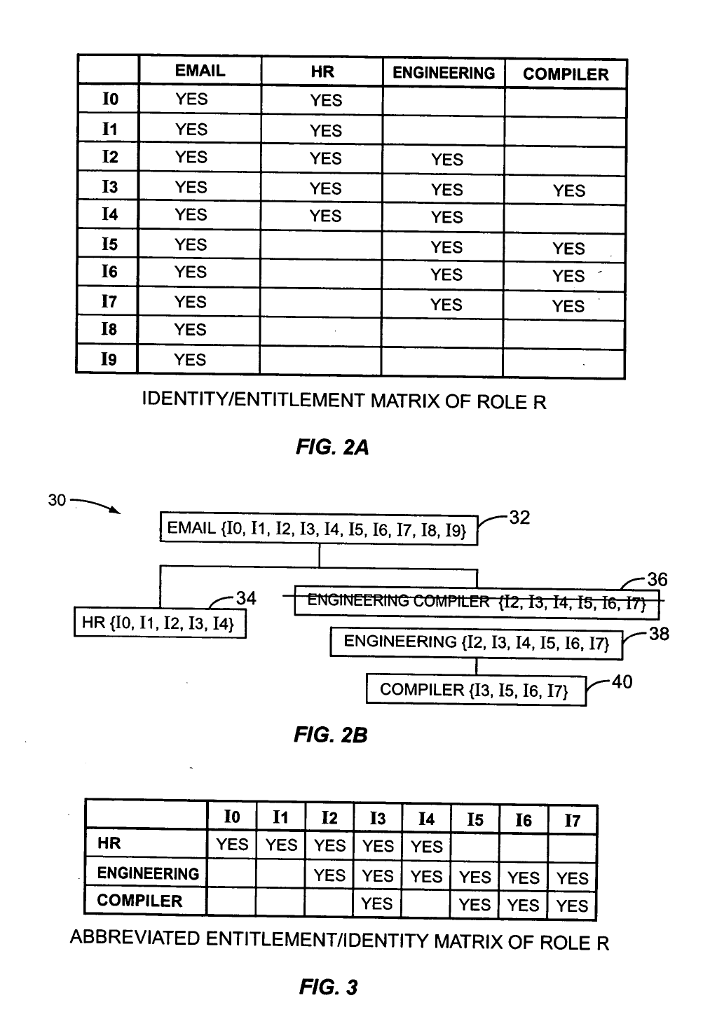

Operation of the role hierarchy algorithm of FIG. 1 is best demonstrated by an example, depicted in FIG. 2. Consider a role R having ten identities (10 . . . 19) with the following entitlements, depicted in tabular form in FIG. 2A:
100% of the identities of the role R have email accounts.
50% of the identities (10 . . . 14) have access to HR records.
60% of the identities (12 . . . 17) have access to engineering servers.
40% of the identities (13, 15 . . . 17) have licenses to a compiler on an engineering server.

The role hierarchy generated for the role R is depicted graphically in FIG. 2B, indicated generally by the numeral 30. In the first pass of a role hierarchy generation process (i.e., the hierarchy level equals zero), the role R is inspected and found to be non-cohesive. That is, the role R contains at least one entitlement with less than 100% relevance. Stated another way, at least one entitlement is not associated with each and every identity that comprises the role.

The role R is then inspected to ascertain whether it contains at least one entitlement that does have 100% relevance. In this case, the answer is yes—all of the identities of the role have an email account. A node role 32 (since this is the first pass, the node role 32 is a root node role) is generated, comprising the identities 10 . . . 19—that is, all of the identities of the role R.

The role is then re-clustered into new roles, based on the non-1 00% relevance entitlements. That is, the 100% relevance entitlements used to define the preceding role 32 are stricken from the identity-entitlement matrix represented by FIG. 2A, and the identities are re-clustered into roles. The resulting roles may vary based on the clustering algorithm and heuristics, rules, options, and constraints imposed on it. One possible result of such re-cluster would generate two additional roles: role 34 comprising identities 10..14 having HR entitlements, and role 36 comprising identities 12 . . . 17 having engineering and compiler accesses. These roles are added to the hierarchy 30 as child nodes to node 32, as depicted in FIG. 2B. As no non-cohesive roles remain at the current (zero) level, the level increments and the next level (containing roles 34 and 36) is searched for non-cohesive roles.

Role 34 is cohesive; as such, it is fully optimized and is not processed further. Role 36, however, is non-cohesive. That is, it contains at least one entitlement that is not shared by all identities. The composition of role 36 is as follows:
100% of identities (12 . . . 17) have engineering server access.
66% of identities (13, 15 . . . 17) have compiler licenses.

Since role 36 has at least one entitlement with 100% relevance, a new role 38 is formed comprising only those identities possessing the 100% relevance entitlement (in this case, engineering server access), and added to the role hierarchy in place of the non-cohesive role 36 (indicated in FIG. 2B by strike-through of role 36). The remaining identities are re-clustered based on the non-100% relevance entitlement, which in this case is compiler license, into a new role 40, which is added as a child to role 38. Since role 40 is cohesive, no further iterations are required, and the role hierarchy is complete.

For clarity, each level of the example of FIG. 2 includes a role having 100% relevance. In general, of course, this may not be the case. If, at any level, a non-cohesive role under consideration is found not to possess any 100% relevance entitlement, the role is re-clustered at that level, with the two or more newly created roles replacing the re-clustered role. The process then continues, inspecting each of the newly created roles for cohesiveness, and if found non-cohesive, for an entitlement with 100% relevance.

Inspection of the role hierarchy 30 reveals several advantages to the present invention. First, note that the hierarchy 30 can present a “security gradient” of the organization (as represented by initial role R), with the most common level of security at the top, or root, node 32. The bottom, or leaf, nodes 34 and 40 have the most specific security access. Note also that at each node, every identity inherits all accesses that define the nodes above it, all the way back to, and including, the root node 32. Thus, the high-security access roles may be inspected and analyzed without the clutter of lower-security accesses that the identities )also possess, but which may complicate or obscure an analysis or search of the high-security roles.

Additionally, patterns among the roles emerge that are not apparent from a flat list of generated roles, or inspection of a table such as FIG. 2A (particularly as in a real application, such a table may include multiple thousands of cells). For example, all identities in role 40, with access to compiler licenses and members of only higher-level roles, are likely engineers. What of identities of role 38, having access to engineering servers? The role hierarchy 30 shows that some identities of role 38 (specifically, 12, 13 and 14) also are clustered into role 34, characterized by HR access. These individuals are likely engineering managers. Similarly, identities clustered into roles 34 and 40 that are not also clustered elsewhere (other than at higher levels in the role hierarchy 30), are likely HR staff and engineers, respectively. This sort of cross-functional role membership is not readily apparent using non-hierarchical role analysis. In particular, since the role hierarchy.30 is generated automatically according to the present invention, it reflects roles revealed by analysis of an organization's existing, actual security structure. As such, the present invention provides a powerful tool, both to spot and correct erroneous existing access permissions, and to discover and exploit existing cross-functional activity in the organization's actual operations.

These relationships may be discovered in another way, according to another embodiment of the present invention. In automated role discovery, and identity/entitlement matrix (such as that depicted in FIG. 2A) is formed from data mined from an organization's existing systems. These identities are clustered according to various proximity algorithms into roles, wherein each identity, with all of that identity's entitlements, is clustered into exactly one role. The discovered roles are mutually exclusive with respect to identities, but many roles may include the same entitlements.

According to one embodiment of the present invention, the identities and entitlements of the identity/entitlement matrix are transposed, and roles comprising entitlements are clustered based on the identities that possess them. This role discovery scheme results in roles that are mutually exclusive with respect to entitlements, but which may share identities among many roles.

For example, FIG. 3 depicts the entitlement/identity matrix for the group above with respect to FIG. 2A (e.g., role R). The email entitlement is omitted, as every individual in that group possess that entitlement. The entitlements of FIG. 3 may be clustered into roles based on the identities possessing the entitlements in a broad number of ways, based on the clustering algorithm and heuristics, rules, options, and constraints imposed on it. Two possible roles that may be generated are as follows:
Role 1: Entitlements={HR}; Identities=(I0,I1,I2,I3,I4)
Role 2: Entitlements={engineering, compiler}; Identities=(I2,I3,I4,I5,I6,I7}

By inspection of the roles generated in this example, we see that identities I2, I3, and I4 are clustered into both roles, suggesting that the associated individuals have a cross-functional role in the organization between access permissions relating to HR and those relating to engineering/compiler—which may suggest engineering management. Alternatively, it could flag engineers with erroneous access to HR data, or visa-versa.

We may also note by inspection the relevance of the generated roles. In Role 1, for example, all of the identities in the role possess all of the entitlements. In Role 2, however, only the engineering entitlement has 100% relevance (it is possessed by all of the identities of the role); the compiler entitlement has only a 66% relevance (it is possessed by four of the six role identities). In a real application, of course, the number of entitlements will be large, and the number of identities may be very large, such that the creation of non-cohesive roles with varying degrees of entitlement relevance is virtually assured. To manage such situations, the roles generated from an entitlement/identity matrix such as FIG. 3 may be processed into a hierarchical arrangement of fully cohesive roles, as described above.

Note that as defined above, with respect to roles generated by clustering individuals having attributes, the clustering based on the attributes, a “non-cohesive” role is one in which not all attributes are possessed by all identities. Alternatively, with respect to roles generated by clustering attributes possessed by individuals, the clustering based on the individuals, a “non-cohesive” role is one in which not all individuals possess all attributes. These disparate definitions arise from the inversion of the identity/attribute matrix prior to clustering in the latter case. In other words, the definition is embodiment-specific. In general, according to the present invention, roles are formed by clustering a first parameter, with which are associated one or more second parameters, into mutually exclusive groups with respect to the first parameter. The clustering is performed based on the second parameter. That is, the clustering process utilizes various proximity algorithms to detect and operate on similarities in the second parameters or sets of second parameters, to group the first parameters into roles. As used herein, the terms “cohesive,” “non-cohesive,” and “relevance” refer to the population of second parameter(s) in a role, and whether they are associated with some, or all, of the first parameter(s). Specifically, a role is cohesive if each and every second parameter in the role is associated with each and every first parameter. A role is non-cohesive if one or more second parameters in a role are not associated with at least one first parameter. Finally, the relevance of a second parameter is the percentage of first parameters in the role with which it is associated.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of automatically hierarchically arranging roles in a role based control system, each role comprising a plurality of identities having attributes, to generate a role hierarchy, comprising, iteratively at each level of said hierarchy:
automatically replacing, at the same hierarchical level, each non-cohesive role, defined as a role wherein at least one attribute is not possessed by every identity in the role, with a cohesive role formed by grouping identities having at least one common attribute into said cohesive role; and
automatically clustering the remaining identities into children roles based on attributes other than said common attribute; and
automatically adding said children roles to said role hierarchy at a hierarchical level below said cohesive role.

2. The method of claim 1, wherein automatically replacing each non-cohesive role comprises, if no common attribute exists in said role, automatically clustering said role into two or more new roles based on all attributes in said non-cohesive role, and automatically replacing said non-cohesive role with said new roles at the same hierarchical level.

3. The method of claim 1 wherein said role based control system is a role based access control system in which system access permissions are associated with each role, and wherein roles at lower hierarchical levels inherit the access permissions of all higher-level roles.

4. The method of claim 3 wherein said role hierarchy defines a security gradient ranging from the most common security access at the root node(s) and the most specific security access at the leaf nodes or vice versa.

5. A method of automatically hierarchically arranging roles in a role based control system to generate a role hierarchy, comprising:
(a) providing, at a first hierarchical level, at least one role comprising identities possessing attributes;
(b) for each role at the current hierarchical level for which less than all identities possess every attribute, automatically examining the number of identities possessing each attribute;
(1) if at least one attribute is possessed by every identity in the role,
automatically replacing said role, at the current hierarchical level, with a node role comprising only the identities possessing the common attribute; and
automatically re-clustering the remaining identities into new roles based on attributes other than the common attribute, and automatically adding the new roles to the hierarchy at a hierarchical level below said node role;
(2) if at least one attribute is not possessed by every identity in the role,
automatically re-clustering the identities in said role into new roles based on all attributes, and replacing said role, at the current hierarchical level, with the new roles; and
(c) repeating step (b) for each level in the hierarchy.

6. The method of claim 5 wherein providing, at a first hierarchical level, at least one role comprising identities possessing attributes comprises automatically extracting identities and associated attributes from data sources, and automatically clustering said identities into roles based on said attributes.

7. The method of claim 6 wherein said attributes are selected from the group including job title, location, department, exempt status, pay rate, and date of hire.

8. The method of claim 5 wherein roles in said hierarchy possess properties, and wherein each role inherit the properties of the role from the role in a higher level of said hierarchy from which it was reclustered.

9. A method of automatic role discovery, comprising:
automatically extracting identities and associated attributes from one or more data sources;
automatically clustering said attributes into roles, based on said identities; and
incorporating said roles into a role based control system.

10. The method of claim 9 further comprising automatically hierarchically ranking said roles to generate a role hierarchy, comprising, iteratively at each level of said hierarchy:
automatically replacing, at the same hierarchical level, each non-cohesive role, defined as a role wherein at least one identity does not possess every attribute in the role, with a cohesive role formed by grouping attributes having common identity ownership into said cohesive role; and
automatically clustering the remaining attributes into child roles based on identities other than those possessing said common attribute; and
automatically adding said child roles to said role hierarchy at a hierarchical level below said cohesive role.

11. The method of claim 10, wherein automatically replacing each non-cohesive role comprises, if no identity possesses every attribute in said role, automatically clustering said role into two or more new roles based on all identities in said non-cohesive role, and automatically replacing said non-cohesive role with said new roles at the same hierarchical level.

12. The method of claim 9 wherein said attributes include entitlements comprising the associated identity's access to resources, and wherein said role based control system is a role based access control system.

13. A computer readable medium including one or more computer programs operative to cause a computer to generate a role hierarchy for roles in a role based control system, each role comprising a plurality of identities having attributes, the computer programs causing the computer to perform the steps of:
for each hierarchical level,
replacing, at the same hierarchical level, each non-cohesive role, defined as a role wherein at least one attribute is not possessed by every identity in the role, with a cohesive role formed by grouping identities having at least one common attribute into said cohesive role; and
clustering the remaining identities into child roles based on attributes other than said common attribute; and
automatically adding said child roles to said role hierarchy at a hierarchical level below said cohesive role.

14. The computer readable medium of claim 13, wherein replacing each non-cohesive role comprises, if no common attribute exists in said role, automatically clustering said role into two-or more new roles based on all attributes in said non-cohesive role, and automatically replacing said non-cohesive role with said new roles at the same hierarchical level.

15. The method of claim 13 wherein said role based control system is a role based access control system in which system access permissions are associated with each role, and wherein roles at lower hierarchical levels inherit the access permissions of all higher-level roles.

16. A computer readable medium including one or more computer programs operative to cause a computer to generate roles suitable for a role based control system, the computer programs causing the computer to perform the steps of:
extracting identities and associated attributes from one or more data sources;
clustering said attributes to form recommended roles, based on said identities; and
incorporating said recommended roles into a role based control system.

17. The computer readable medium of claim 16, said computer programs causing the computer to further perform the steps of:
displaying said recommended roles prior to said incorporation; and
modifying said recommended roles based on input by an administrator, said modifications causing a re-clustering of said identities to form revised recommended roles; and
wherein incorporating said recommend roles into a role based control system comprises incorporating said revised recommended roles into said role based control system.

18. The method of claim 16 wherein said attributes include entitlements comprising the associated identity's access to resources, and wherein said role based control system is a role based access control system.

19. The computer readable medium of claim 16, said computer programs further operative to hierarchically ranking said roles to generate a role hierarchy, by causing the computer to further perform the steps of:
for each hierarchical level,
replacing, at the same hierarchical level, each non-cohesive role, defined as a role wherein at least one identity does not possess every attribute in the role, with a cohesive role formed by grouping attributes having common identity ownership into said cohesive role; and
clustering the remaining attributes into child roles based on identities other than those possessing said common attribute; and
adding said child roles to said role hierarchy at a hierarchical level below said cohesive role.

20. The method of claim 19, wherein replacing each non-cohesive role comprises, if no identity possesses every attribute in said role, automatically clustering said role into two or more new roles based on all identities in said non-cohesive role, and automatically replacing said non-cohesive role with said new roles at the same hierarchical level.
